(19) United States
(12) Patent Application Publication
(10) Pub. No.: US 2006/0067532 A1
(43) Pub. Date: Mar. 30, 2006

(54) Communication unit and communication method

(76) Inventors: Yoshio Kimura, Ome-shi (JP); Noriya Sakamoto, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/235,071

(22) Filed: Sep. 27, 2005

(30) Foreign Application Priority Data
Sep. 27, 2004 (JP) 2004-280694

(51) Int. Cl. H04L 9/00

(52) U.S. Cl. 380/277

(57) ABSTRACT

A communication unit of the invention has a ciphering section which ciphers a content signal with a cipher key and outputs a ciphered content signal, a key ciphering section which ciphers the cipher key with the static device key and the dynamic device key preliminarily stored and outputs a ciphered cipher key, communication sections which makes communication in order to record the ciphered content signal in a predetermined unit on the network and record the ciphered cipher key in a predetermined region on the network, and a key updating section which, when the cipher key is abolished, updates the stored dynamic device key.

### CROSS-REFERENCE TO RELATED APPLICATIONS

This application is based upon and claims the benefit of priority from prior Japanese Patent Application No. 2004-280694, filed Sep. 27, 2004, the entire contents of which are incorporated herein by reference.

### BACKGROUND OF THE INVENTION

1. Field of the Invention

The present invention relates to a communication unit such as a TV unit having a network function, and more particularly, to a communication unit and a communication method capable of improving security of video/audio signals sent through a network using a deciphering function.

2. Description of the Related Art

As well known, in recent years, digitalization of TV broadcasting has been progressed. For example, in Japan, terrestrial digital broadcasting has been started as well as satellite digital broadcasting such as broadcasting satellite (BS) and 110-degree communication satellite (CS).

A digital communication unit for receiving digital TV broadcasting is capable of carrying out recording, reproduction, retrieval, management and the like of content information and utilization of electronic program information because it is capable of handling video and audio information in the form of digital signals. As this example, patent document 1 (Jpn. Pat. Appln. KOKAI Publication No. 2002-142163) has disclosed technology for acquiring electronic program information from digital TV broadcasting and applying it.

However, the patent document 1 does not indicate how acquired digital content is used through a network, and further, it indicates nothing about a deciphering method which is used when the network is used, which is problematic.

### BRIEF SUMMARY OF THE INVENTION

According to an embodiment of the present invention, there is provided a communication unit comprising: a ciphering section (81) which ciphers a given content signal (C) with a cipher key (K_{c}) and outputs a ciphered content signal (K_{c}·C); a key ciphering section (73) which has a static device key (k) and a dynamic device key (K1) preliminarily stored in a storage region (74), ciphers the cipher key (K_{c}) with the static device key (k) and the dynamic device key (K1), and outputs a ciphered cipher key (k·K1·K_{c}); a communication section (69 to 72) which makes communication in order to record the ciphered content signal (K_{c}·C) which is ciphered by the ciphering section at a predetermined unit on the network (25) and record the ciphered cipher key (k·K1·K_{c}) outputted by the key ciphering section in a predetermined region on the network (28); a key deciphering section (73) which reads out the ciphered cipher key (k·K1·K_{c}) from the predetermined region through the communication section corresponding to user's reproduction instruction, and deciphers to the cipher key (K_{c}) with the static device key (k) and the dynamic device key (K1); a deciphering section (81) which reads out the ciphered content signal (K_{c}·C) from the predetermined unit through the communication section, and deciphers to the content signal (C) with the cipher key (K_{c}) deciphered by the key deciphering section; a reproducing section (47) which reproduces the content signal (C) deciphered by the deciphering section; and a key updating section (72) which, when the cipher key (K_{c}) is abolished, updates the stored dynamic device key.

### BRIEF DESCRIPTION OF THE SEVERAL VIEWS OF THE DRAWING

FIG. 1 is an explanatory diagram for schematically explaining a digital TV communication unit according to an embodiment of the present invention and an example of network system constituted around the unit;

FIG. 2 is a block diagram showing an example of a configuration of a digital TV communication unit according to the embodiment of the invention;

FIG. 3 is a block diagram showing an example of a remote controller of the digital TV communication unit according to the embodiment of the invention;

FIG. 4 is a system diagram for explaining an example of a key control method of the digital TV communication unit according to the embodiment of the invention;

FIG. 5 is a flow chart for explaining an example of deciphering processing of the digital TV communication unit according to the embodiment of the invention; and

FIG. 6 is a flow chart for explaining an example of the deciphering processing of the digital TV communication unit according to the embodiment of the invention.

### DETAILED DESCRIPTION OF THE INVENTION

Hereinafter, one embodiment of the present invention will be described in detail with reference to the accompanying drawings.

<TV Unit Equipped With Network Function According to the Present Invention>

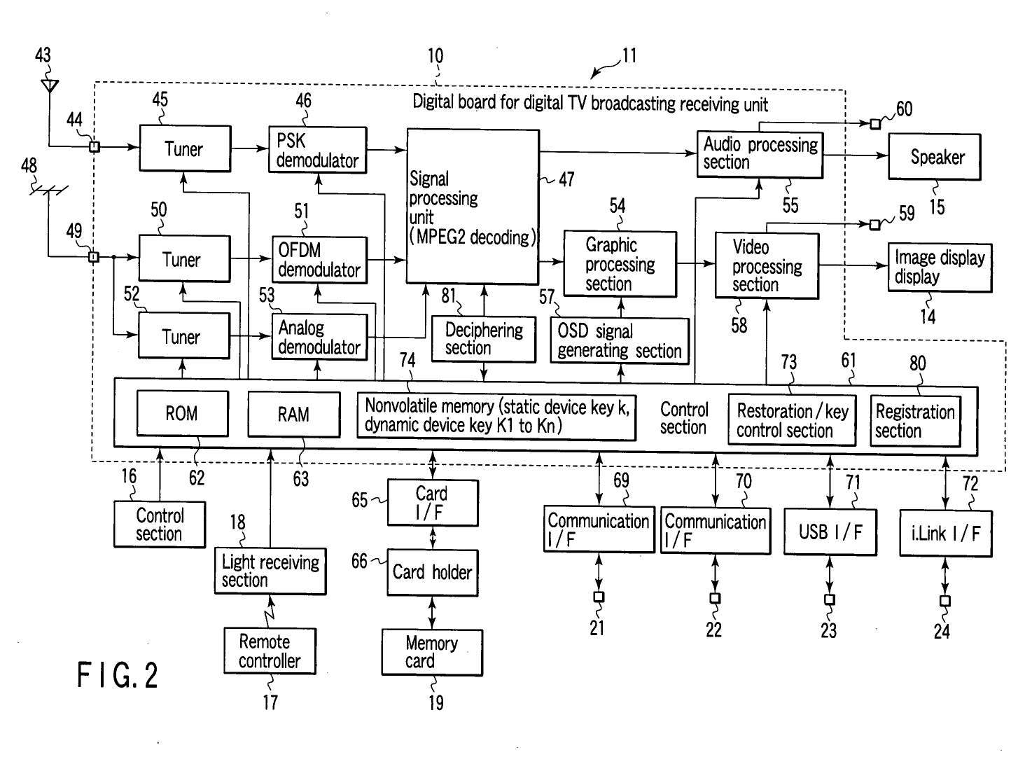

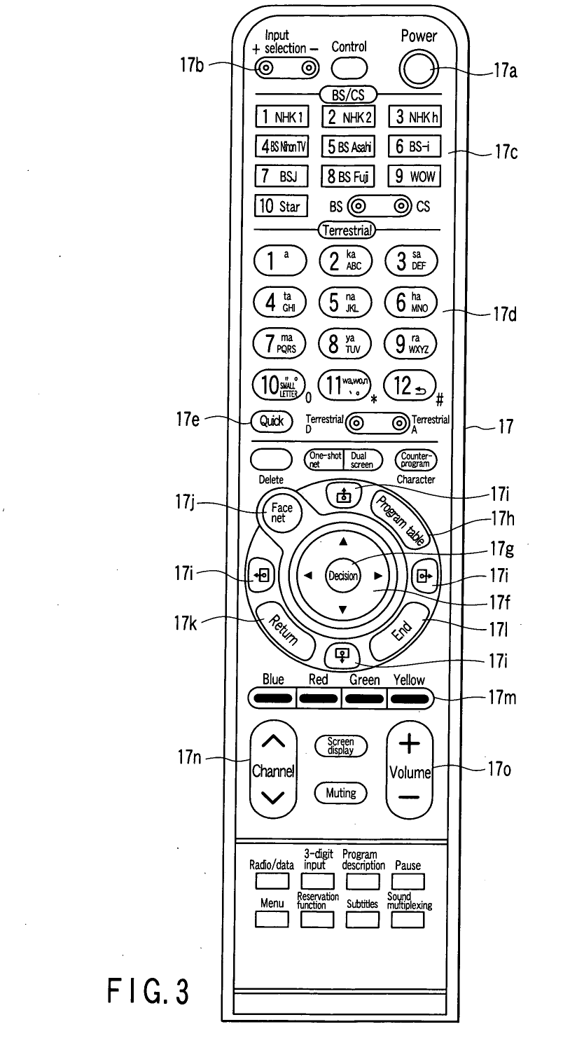

First, an example of a TV unit equipped with a network function, which is a communication unit according to the invention, will be described with reference to the accompanying drawings. FIG. 2 is a block diagram showing an example of a configuration of the digital TV communication unit according to the embodiment of the invention. FIG. 3 is a block diagram showing an example of a remote controller of the digital TV communication unit according to the embodiment of the invention.

A digital TV communication unit 11 mainly comprises a thin cabinet 12 and a supporting base 13 for supporting the cabinet 12 in its erected condition. The cabinet 12 includes a flat panel type image display unit 14 composed of, for example, a liquid crystal panel or the like, a speaker 15, an operating section 16, a light receiving section 18 for receiving operating information sent from a remote controller 17, and the like.

The digital TV communication unit 11 can be equipped with an attachable and detachable memory card 19, for example, a secure digital (SD) memory card, a multimedia card (MMC), a memory card such as a memory stick or a memory card (IC card), in which subscription information and the like are recorded. Recording and reproduction of information such as program and photograph are carried out in the memory cards 19.

The digital TV communication unit 11 comprises a first local area network (LAN) terminal 21, a second LAN terminal 22, a universal serial bus (USB) terminal 23 and an i.Link terminal 24.

Of these, the first LAN terminal 21 is used as a LAN correspondence HDD special port and is used for recording and reproduction of information to the LAN correspondence HDD 25 which is a connected network attached storage (NAS) under Ethernet (trade name).

By providing with the first LAN terminal 21 as a LAN correspondence HDD special port, information recording of a high-vision quality program can be stably carried out to the HDD 25 without being affected by other network environment, network usage condition and the like.

The second LAN terminal 22 is used as a general LAN correspondence port using Ethernet and for connecting such as units a LAN correspondence HDD 27, a personal computer (PC) 28, digital versatile disk (DVD) recorder 29 containing HDD and the like and exchanging information with these units, for example, through a hub 26.

Because the DVD recorder 29 communicates only digital information about control system through the second LAN terminal 22, it is necessary to provide with a special analog transmission passage 30 in order to exchange analog video and audio information with a digital TV communication unit 11.

Further, the second LAN terminal 22 is connected to, for example, a network 32 like Internet through a broadband router 31 connected to the hub 26 and used to exchange information with a PC 33, portable phone 34 and the like through the network 32.

The USB terminal 23 is used as a general USB correspondence port and connects a USB units such as a portable phone 36, a digital camera 37, a card reader/writer 38 to a memory card, a HDD 39 and keyboard 40, for example, through a hub 35 in order to exchange information with these USB units.

The i.Link terminal 24 serially connects, for example, an AV-HDD 41, a digital video home system (D-VHS) 42 and the like in order to exchange information with these units.

FIG. 2 shows main signal processing systems of the digital TV communication unit 11. That is, a satellite digital TV broadcasting signal received by an antenna 43 for BS/CS digital broadcasting reception is supplied to a tuner 45 for satellite digital broadcasting through an input terminal 44 so as to select a broadcasting signal of a desired channel.

The broadcasting signal selected by the tuner 45 is supplied to a phase shift keying (PSK) 46, demodulated to digital video signal and audio signal and then outputted to a signal processing section 47.

Further, a terrestrial digital TV broadcasting signal received by an antenna 48 for terrestrial broadcasting reception is supplied to the a tuner 50 for terrestrial digital broadcasting through an input terminal 49 so as to select a broadcasting signal of a desired channel.

A broadcasting signal selected by the tuner 50 is supplied to an orthogonal frequency division multiplexing (OFDM) 51 and after demodulated to digital video signal and audio signal, outputted to the signal processing section 47.

A terrestrial analog TV broadcasting signal received by the antenna 48 for the terrestrial broadcasting reception is supplied to a tuner 52 for terrestrial analog broadcasting through the input terminal 49, so as to select a broadcasting signal of a desired channel. Then, the broadcasting signal selected by the tuner 52 is supplied to an analog demodulator 53 and after demodulated to analog vide signal and audio signal, outputted to the signal processing section 47.

The signal processing section 47 selectively carries out a predetermined digital signal processing, for example, MPEG2 decoding upon digital video signal and audio signal, respectively, supplied from a PSK demodulator 46 and an OFDM demodulator 51 in order to output to a graphic processing section 54 and an audio processing section 55.

The graphic processing section 54 has a function which overlays an OSD signal generated by a on-screen display (OSD) signal generating section 57 on a digital video signal supplied from the signal processing section 47 for output. The graphic processing section 54 can selectively output an output video signal of the signal processing section 47 and an output OSD signal of the OSD signal generating section 57, and output the both outputs in combination, so that they configure each half of the screen.

The digital video signal outputted from the graphic processing section 54 is supplied to the video processing section 58. The video processing section 58 converts the inputted digital video signal to an analog video signal of a format which can be displayed on the image display unit 14, and thereafter, outputs it to the image display unit 14 for graphic representation and at the same time, introduces it to outside through an output terminal 59.

The audio processing section 55 converts the inputted digital audio signal to an analog audio signal of a format which can be reproduced by the speaker 15 and thereafter, outputs to the speaker 15 for audio reproduction and at the same time, introduces to outside through an output terminal 60.

All the operations of the digital TV communication unit 11 including the above-described various kinds of reception operations are controlled integrally by a control section 61. The control section 61 incorporates a central processing unit (CPU) and the like, which controls respective sections by receiving operating information from the operating section 16 or receiving operating information sent from the remote controller 17 through the light receiving section 18 such that the control content is reflected thereon.

In this case, the control section 61 mainly uses a read only memory (ROM) 62 which stores a control program to be executed by the CPU, a random access memory (RAM) 63 for supplying a work area to the CPU and a nonvolatile memory 64 which stores various kinds of setting information and control information.

The control section 61 is connected to a card holder 66 on which the memory card 19 can be loaded through a card interface (I/F) 65. As a consequence, the control section 61 can transmit information through the memory card 19 loaded on the card holder 66 and the card I/F 65. A second memory card (not shown) is connected to the control section 61 through a card I/F (not shown) and the card holder. As a result, the control section 61 can exchange information with the second memory card.

The control section 61 is connected to the first LAN terminal 21 through a communication I/F 69. Consequently, the control section 61 exchange information with the LAN correspondence HDD 25 connected to the first LAN terminal 21 through the communication I/F 69. The control section 61 has a dynamic host configuration protocol (DHCP) server function, and controls by allocating internet protocol (IP) address to the LAN correspondence HDD 25 connected to the first LAN terminal 21.

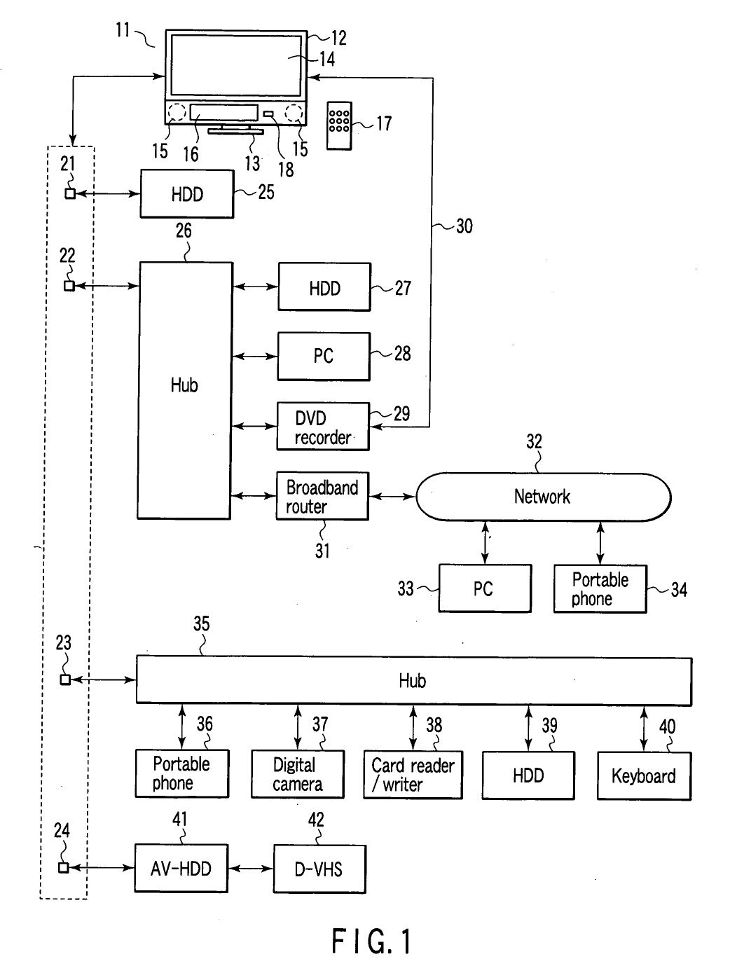

Further, the control section 61 is connected to the second LAN terminal 22 through the communication I/F 70. As a result, the control section 61 can exchange information with each of the units connected to the second LAN terminal 22 (see FIG. 1) through the communication I/F 70.

The control section 61 is connected to the USB terminal 23 through the USB I/F 71. Consequently, the control section 61 exchanges information with each of the units connected to the USB terminal 23 (see FIG. 1) through the USB I/F 71.

The control section 61 is connected to the i.Link terminal 24 through an i.Link I/F 72. Consequently, the control section 61 exchanges information with each of the units connected to the i.Link terminal 24 (see FIG. 1) through the i.Link I/F 72.

FIG. 2 shows an example of a configuration of a digital board 10 loaded with the respective tuner sections 45, 50, 52, the respective demodulators 46, 51, 53, the control section 61, the signal processing section 47 and the like. The configuration of the digital board 10 is an example and may contain other circuit or the respective blocks in the same figure do not need to be provided on the digital board 10, but may be disposed on other substrate.

The control section 61 comprises a restoration/key control section 73, which has a restoration function for restoring a key control system after a digital board 10 in trouble is replaced and a control function for controlling the key control system, a nonvolatile memory 74 for storing static device key k used for the key control system and dynamic devices keys K1 to Kn and a registration section 80 for registering a recording/reproducing unit on the network for recording content information from the TV communication unit 11. For ciphering and deciphering processing, a deciphering section 81 connected to the signal processing section 47 is provided.

FIG. 3 shows the appearance of the remote controller 17. The remote controller 17 is provided with mainly a power key 17a, an input selection key 17b, a satellite digital broadcasting channel direct selection key 17c, terrestrial broadcasting channel direct selection key 17d, a quick key 17e, a cursor key 17f, a decision key 17g, a program table key 17h, a page switch key 17i, a face net (navigation) key 17j, a return key 17k, an end key 17l, blue, red, green, yellow color keys 17m, a channel up/down key 17n, a sound adjustment key 17o, a menu key 17p and the like.

(Cipher key system)

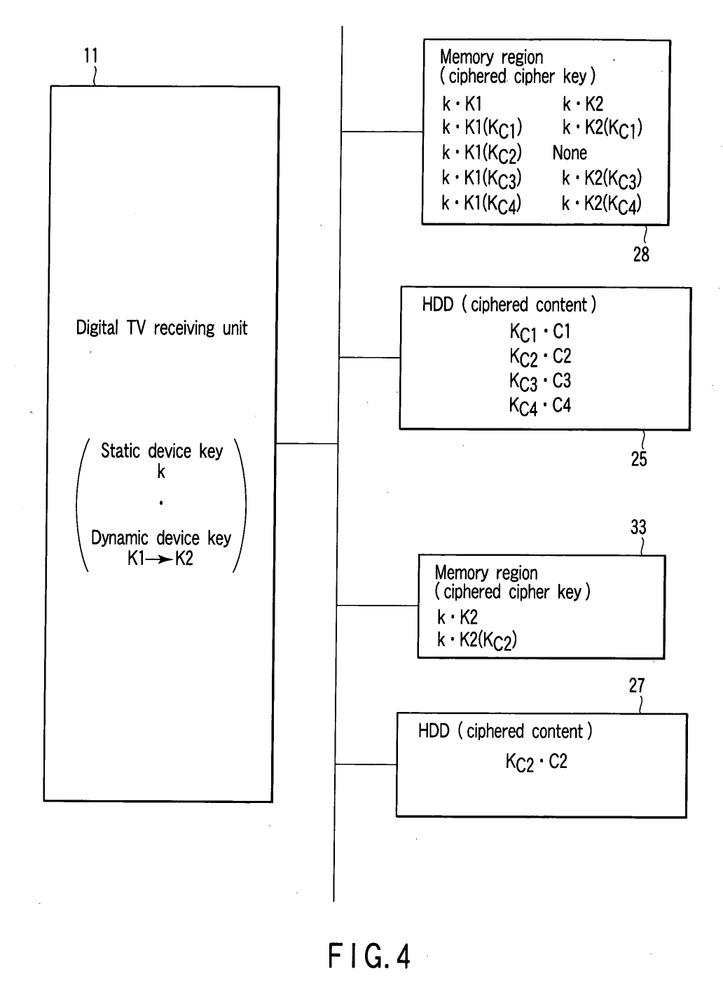

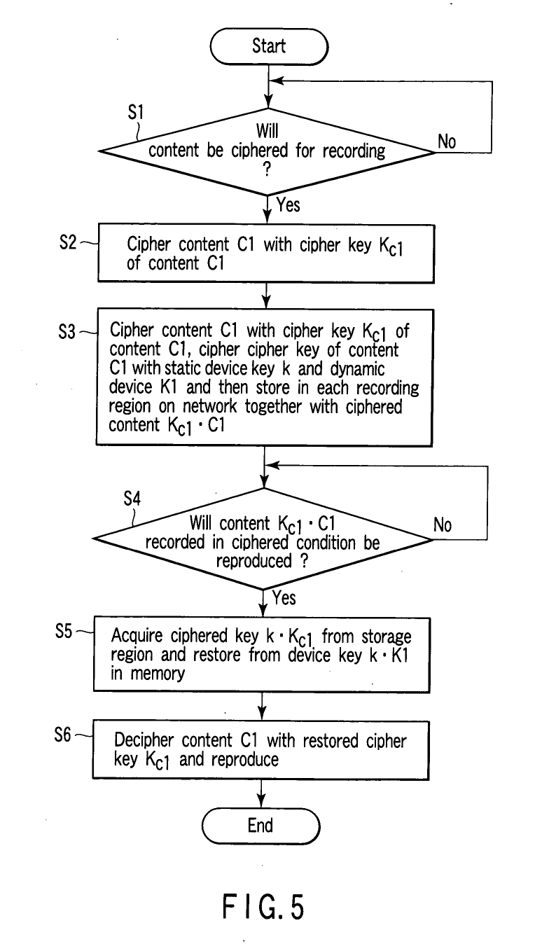

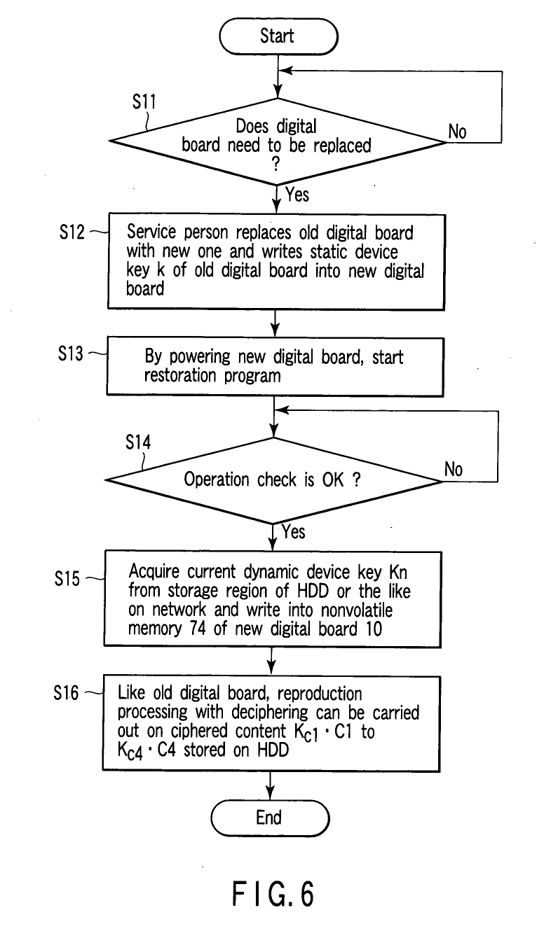

Next, a deciphering system for content information corresponding to the network in the above-described digital TV communication unit will be described in detail with reference to drawings. FIG. 4 is a system diagram for explaining an example of a key control method in the digital TV communication unit according to the embodiment of the invention. FIG. 5 is a flow chart for explaining an example of the deciphering processing of the digital TV communication unit according to the embodiment of the invention. FIG. 6 is a flow chart for explaining an example of the deciphering processing of the digital TV communication unit according to the embodiment of the invention.

That is, the communication unit is, for example, a TV unit having network function and as an example, when it transmits and records content information (C) corresponding to digital broadcasting signal to the HDD 25 or the like on the network, it carries out deciphering processing. Namely, with the content information as ciphered content information (K_{c}·C) ciphered with a cipher key (K_{c}), it is transmitted to a hard disk recorder or the like and recorded.

At this time, the cipher key (K_{c}) used for ciphering is ciphered with a static device key (k) and a dynamic device key (K1 to) stored in the nonvolatile memory 74 and as a ciphered cipher key (k·K1·K_{c}), stored in a personal computer on the network or a predetermined area 25 of the hard disk or the like.

By storing ciphered cipher key (K_{c}) of content information on the network and further recording ciphered content information in a unit on the network, data can be stored on the network with the safety. The cipher key (K_{c}) of the content information is not stored especially on the side of the TV unit, and when decoding the content information, it is acquired again from on the network.

When the TV unit or other unit on the network reproduces content information, it recollects the ciphered cipher key (k·K1·K_{c}) and ciphered content information (K_{c}·C) from on the network and restores the cipher key (K_{c}) of content information with the static device key (k) and dynamic device key (K1 to) stored in the nonvolatile memory 74 and the like. Then, the ciphered content information (K_{c}·C) is restored with the restored cipher key (K_{c}) and supplied for reproduction processing.

The static device key (k) is a cipher key corresponding to a circuit board whose content is never changed. On the other hand, the dynamic device key (K1 to Kn) is updated when invalidating the key with moving and deleting the content information by changing its value from K1 to K2 or from K2 to K3 each time. Not only the update information of the dynamic device key is updated in the nonvolatile memory 74 of the TV unit but also the history of the ciphered cipher key (k·K1·K_{c}) in a predetermined region 25 on the above network is updated. As a consequence, the content information impossible to copy can be moved freely within network while protecting security and copy right on the network.

Next, ciphering processing and deciphering processing will be described in chronological order with reference to a system diagram of FIG. 4 and a flow chart of FIG. 5. That is, if an instruction signal for instructing to cipher and record the content information is dispatched based on controls of the control section 61 and the key control section 73 in the digital TV communication unit 11 (S1), content information C1 is ciphered with cipher key K_{c1} of the content information C1 (S2). At this time, the content information is an output obtained by demodulating broadcasting signal selected by the tuner sections 45, 50, 52 or the like with the respective demodulating sections 46, 51, 53 or the like and executing MPEG2 decoding in the signal processing section 47. Additionally, because the content information C1 is given from the respective interfaces 69 to 72, it is preferable. Next, the content information C1 is ciphered with the cipher key K_{c1} of the content information C1. Although it is preferable that the cipher key K_{c1} is generated by a key generating section (not shown) each time, the present invention is not restricted to this example. The generated cipher key K_{c1} does not always need to be stored and basically it exists on the network.

Next, ciphered content K_{c1}·C1 ciphered by the cipher key K_{c1} is recorded in, for example, HDD 25 on the network, registered by the registration section 80 (S3). At the same time, the cipher key K_{c1} is ciphered with the static device key K and the dynamic device key K1 and transmitted to the PC 28 on the network, for example, registered by the registration section 80 through the communication I/F section 69 and stored there (S3) as the ciphered cipher key k·K1·K_{c1} (S3). The communication I/F section 69 or the like as a communication section executes authentication processing with any unit on the network and after the authentication succeeds, ciphered content signal and ciphered cipher key are transmitted.

Then, if the content information K_{c1}·C1 recorded in ciphered state is reproduced according to user's instruction (S4), the ciphered cipher key k·K1·K_{c1} is acquired from, for example, the PC 28, which is a recording region registered by the registration section 80, and then, the content is restored with the static device key k and the dynamic device key K1 within the nonvolatile memory 74 (S5). Then, the ciphered content information K_{c1}·C1 acquired from the communication I/F 70, which is a communication section, is reproduced with the restored cipher key K_{c1} (S6).

The key control section 73, which is a key updating section, changes the dynamic device key K1 of the storage region 74 to the new dynamic device key K2 in order to disable reproduction by disabling restoration of the ciphered content signal (for example, C2) on the network when the content signal (for example, C2) is moved or deleted. Then, as shown in FIG. 4, ciphered cipher keys (k·K2·K_{c1}, k·K2·K_{c3}, k·K2·K_{c4}) corresponding to all ciphered content signals (for example, C1, C3, C4) reproducible at a current time are recorded as a ciphered cipher key in the hard disk driver 25 on the network. As a consequence, other content information than the content information C2 which cannot be reproduced becomes reproducible after the dynamic device key is updated as well.

(Restoration of Ciphered Key System)

Next, a processing for restoring the aforementioned static device key k and the dynamic device key K1 to Kn in case where the digital board 11 containing the configuration for the above-mentioned cipher key system is replaced due to failure or the like, will be described in detail with reference to a flow chart of FIG. 6.

According to the embodiment of the invention, if the digital board equipped with the static device key k and the dynamic device key K1 to Kn gets into a trouble, it is replaced with a new one like other components by, for example, a service person. At this time, these new keys need to be restored quickly on a new digital board and the restoration section 73 of the control section 61 carries out the restoration processing. That is, on the new digital board as well, if a previous static device key k is inputted by the service person, it is stored, and updated current dynamic device key K1 to Kn is recollected from on the network and restored and then, reproduction of only appropriate ciphered content information on the network, with previous history continued, is guaranteed so as to achieve thorough protection of copy right.

That is, as indicated in the flow chart of FIG. 6, if the digital board 11 needs to be replaced due to a failure or the like in the digital TV communication unit 11 (S11), the service person replaces the old digital board with a new one and at that time, writes the static device key k of the old digital board into the new digital board as a work of the service person (S12). By powering the new digital board, a restoration program in the restoration section 73 is started (S13). Here, the operations of respective functions of the digital board are automatically checked and if a result of the operation check is OK (S14), according to the operation of restoration program, a current dynamic device key Kn (for example, currently K2) is acquired from a predetermined region 28 on the network registered by the registration section 80 and written into the nonvolatile memory 74 of the new digital board 10 (S15).

By the restoration of the restoration section 73, the dynamic device key K1 to Kn of the previous digital board is restored together with the static device key k, so that usage control of content information is continued with the history information of the precious content information reflected.

As described above, in the communication unit, for example, TV unit having the network function, when transferring content information (c) corresponding to digital broadcasting signal to, for example, a hard disk recorder (25) on the network for recording, the content information is transmitted to a hard disk recorder as the ciphered content information (K_{c}·C) produced by ciphering the content information with the cipher key (K_{c}) and recorded therein.

At this time, the cipher key (K_{c}) used for ciphering is ciphered with two keys, the static device key (k) and the dynamic device key (K1 to) stored in the nonvolatile memory 74 and the like and stored in PC on the network or the predetermined region 28 of the hard disk as a ciphered cipher key (k·K1·K_{c}).

Because the content information is stored on the network by ciphering the cipher key and the content information is ciphered and recorded in a unit on the network, data can be stored on the network with the safety. The cipher key (K_{c}) for the content information does not exist on the side of the TV unit and when the content information is demodulated, it is acquired again from on the network.

That is, when reproducing content information in the TV unit, the ciphered cipher key (k·K1·K_{c}) and the ciphered content information (K_{c}·C) are recollected from on the network and the cipher key (K_{c}) of the content information is restored with two keys, the static device key (k) and the dynamic device key (K1 to) stored in the nonvolatile memory 74 and the like. Then, the ciphered content information (K_{c}·C) are restored with the restored cipher key (K_{c}) and used for reproduction processing.

The static device key (k) is a cipher key corresponding to a circuit board whose content is never changed and on the other hand, the dynamic device key (K1 to Kn) is updated when the key is invalidated by moving or deleting the content information so that its value changed from K1 to K2 or from K2 to K3 each time. Not only the update information of the dynamic device key is updated by the nonvolatile memory 74 of the TV unit but also the history of the ciphered cipher key (k·K1·K_{c} . . . ) in the predetermined region 25 on the above network is updated. As a consequence, a processing for moving the content information which cannot be copied, freely within a network is made possible with the security on the network and copy right protected.

Further, the embodiment of the invention has a restoration function of when a digital board loaded with the static device key (k) and the dynamic device key (K1 to Kn) gets into a trouble or is replaced with a new one, restoring quickly these keys for a new digital board. That is, the new digital board stores the previous static device key (k) when the service person inputs it and recollects a updated current dynamic device key (K1 to Kn) from on the network and restores it, so that only an appropriate ciphered content on the network can be reproduced with the precious history kept.

Those skilled in the art can realize the present invention according to the above-described various embodiments and further, they can imagine various modifications of these embodiments easily and even if he has no inventive capability, the present invention can be applied to various embodiments. Therefore, the present invention extends over a wide range not inconsistent with a disclosed principle and novel feature and is not restricted to the above-described embodiments.

What is claimed is:

1. A communication unit comprising:
a ciphering section which ciphers a given content signal with a cipher key and outputs a ciphered content signal;
a key ciphering section which has a static device key and a dynamic device key preliminarily stored in a storage region, ciphers the cipher key with the static device key and the dynamic device key, and outputs a ciphered cipher key;
a communication section which makes communication in order to record the ciphered content signal which is ciphered by the ciphering section at a predetermined unit on the network and record the ciphered cipher key outputted by the key ciphering section in a predetermined region on the network;
a key deciphering section which reads out the ciphered cipher key from the predetermined region through the communication section corresponding to user's reproduction instruction, and deciphers to the cipher key with the static device key and the dynamic device key;
a deciphering section which reads out the ciphered content signal from the predetermined unit through the communication section, and deciphers to the content signal with the cipher key deciphered by the key deciphering section;
a reproducing section which reproduces the content signal deciphered by the deciphering section; and
a key updating section which, when the cipher key is abolished, updates the stored dynamic device key.

2. The communication unit according to claim 1, further comprising:
a restoration section which, when a circuit board loaded with the key ciphering section and the key deciphering section is replaced with a new one, restores the static device key and the dynamic device key of a previous circuit board in the new circuit board.

3. The communication unit according to claim 1, wherein the restoration section is provided on the circuit board, and the static device key of the previous circuit board is inputted by a user or a service person while as for the dynamic device key of the previous circuit board, the restoration section acquires the dynamic device key stored in a predetermined region on the network through the communication section and the network and stores it to restore the previous circuit board.

4. The communication unit according to claim 3, further comprising:
a registration section which registers a predetermined unit on the network for recording the content signal repeatedly and a predetermined region on the network for recording the ciphered cipher key repeatedly,
wherein as for the dynamic device key, the restoration section acquires the dynamic device key of the previous circuit board stored in the predetermined region on the network based on a registration of the registration section through the communication section and the network, and stores it to restore the previous circuit board.

5. The communication unit according to claim 3, wherein, when the content signal is moved or deleted, the key updating section changes the dynamic device key in the storage region to a new dynamic device key so as to disable the ciphered content signal on the network from being reproduced by disabling it from being deciphered and records a ciphered cipher key corresponding to all the ciphered content signals possible to reproduce currently in a predetermined region on the network.

6. The communication unit according to claim 1, wherein the storage region which stores the static device key and the dynamic device key is a nonvolatile memory.

7. The communication unit according to claim 1, further comprising:
a tuner section which receives a broadcasting signal to tune it and outputs a tuned signal; and
a demodulating section which supplies a video/audio signal obtained by demodulating the tuned signal from the tuner section to the ciphering section as the content signal.

8. The communication unit according to claim 7, further comprising:
a signal processing section which supplies a video/audio signal obtained by MPEG decoding the video audio signal outputted by the demodulating section to the ciphering section as the content signal.

9. The communication unit according to claim 1, wherein the communication section executes authentication with the predetermined unit on the network and a unit which provides the predetermined region, and after the authentication succeeds, transmits the ciphered content signal or ciphered cipher key.

10. The communication unit according to claim 1, wherein the communication unit includes at least one of a LAN terminal, a USB terminal and an i.Link terminal.

11. A communication method comprising:
ciphering a given content signal with a cipher key and outputting a ciphered content signal;
with a static device key and a dynamic device key preliminarily stored in a storage region, ciphering the cipher key with the static device key and the dynamic device key and outputting a ciphered cipher key;
making communication in order to record the ciphered content signal in a predetermined unit on the network and record the ciphered cipher key in a predetermined region on the network;
reading out the ciphered cipher key from the predetermined region corresponding to user's reproduction instruction and deciphering to the cipher key with the static device key and the dynamic device key;
reading out the ciphered content signal from the predetermined unit through the network and deciphering to the content signal with the cipher key;
reproducing the deciphered content signal; and
when the cipher key is abolished, updating the stored dynamic device key.

12. The communication method according to claim 11, further comprising:
when a circuit board which executes the key ciphering processing and the key deciphering processing is replaced with a new one, restoring the static device key and the dynamic device key of a previous circuit board in the new circuit board.

13. The communication method according to claim 11, wherein the static device key of the previous circuit board is inputted by a user or a service person while as for the dynamic device key of the previous circuit board, the dynamic device key stored in a predetermined region on the network is acquired through the network and stored to restore the previous circuit board.

14. The communication method according to claim 13, further comprising:
registering a predetermined unit on the network for recording the content signal repeatedly and a predetermined region on the network for recording the ciphered cipher key repeatedly,
wherein as for the dynamic device key of a previous circuit board, the previous dynamic device key stored in the predetermined region on the network is acquired based on the registration through the network and stored to restore the previous circuit board.

15. The communication method according to claim 13, further comprising:
when the content signal is moved or deleted, changing the dynamic device key in the storage region to a new dynamic device key so as to disable the ciphered content signal on the network from being reproduced by disabling it from being deciphered and further recording a ciphered cipher key corresponding to all the ciphered content signals possible to reproduce currently in a predetermined region on the network.

16. The communication method according to claim 11, wherein the storage region which stores the static device key and the dynamic device key is a nonvolatile memory.

17. The communication method according to claim 11, further comprising:
receiving a broadcasting signal to tune and output it and supplying video audio signal obtained by demodulating the tuned signal for the ciphering processing as the content signal.

18. The communication method according to claim 17, further comprising:
supplying the video audio signal obtained by MPEG decoding the video audio signal for the ciphering processing as the content signal.

19. The communication method according to claim 11, further comprising:
executing authentication with the predetermined unit on the network and a unit providing the predetermined region, and after the authentication succeeds, transmitting the ciphered content signal or ciphered cipher key.

20. The communication method according to claim 11, wherein communication processing of the network uses at least one of a LAN terminal, a USB terminal and an i.Link terminal.
